(19) United States
(12) Patent Application Publication
(10) Pub. No.: US 2009/0141597 A1
(43) Pub. Date: Jun. 4, 2009

(54) NEAR FIELD OPTICAL RECORDING DEVICE AND A METHOD OF OPERATING A NEAR FIELD OPTICAL RECORDING DEVICE

(75) Inventor: Coen Adrianus VERSCHUREN, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/298,149

(22) PCT Filed: Apr. 12, 2007
(86) PCT No.: PCT/IB2007/051317

§ 371 Date: Oct. 23, 2008

(30) Foreign Application Priority Data
Apr. 25, 2006 (EP) 06113102.5

(51) Int. Cl. G11B 7/00

(52) U.S. Cl. 369/43; 369/112.24; G9B/7

(57) ABSTRACT

A near field optical recording device and method of operating a near field optical recording device, the device being arranged to cooperate with an optical record carrier. The device comprising means to adjust tilt of a refractive optical element with respect to the optical record carrier according to a distance between the refractive optical element and the data layer of the optical record carrier to be accessed.

### FIELD OF THE INVENTION

The invention relates to the field of near field optical recording devices. In particular, the invention relates to a near field optical recording device comprising:

a light source,

a refractive optical element arranged to direct light from the light source towards the optical record carrier,

a tilt error servo loop comprising a tilt error signal related to the tilt of the refractive optical element with respect to the optical record carrier,

and a tilt servo gain setting, applied to the tilt error signal.

### BACKGROUND OF THE INVENTION

The maximum data density that can be recorded on an optical record carrier in an optical recording device inversely scales with the size of the laser spot that is focused onto the optical record carrier. The spot size is determined by the ratio of two optical parameters, namely, the wavelength of the light source of the device (usually a laser) and the numerical aperture (NA) of the refractive optical element (often an objective lens) employed to direct light from the light source onto an optical record carrier. In conventional optics, the NA is limited to a value smaller than 1.0. In near field optical recording, however, the NA can be made larger than 1.0 by use of e.g. a solid immersion lens (SIL) as the refractive optical element, thus allowing further extension to larger storage densities of data on an optical record carrier. An NA greater than 1.0 is only available within an extremely short distance form the SIL, a distance typically smaller than one tenth of the wavelength of the light. As a result the SIL and optical record carrier must be kept within a few ten's of nanometers of each other during operation. The distance between the refractive optical element and the optical record carrier (the air gap) is accurately controlled by an air gap control system using conventional focus and tracking actuator in combination with a very sensitive gap error signal, which is derived from a polarization detection of the reflected light.

A near field optical recording system is further described in Optical Data Storage 2004, Proceedings of SPIE Vol 5380, pp 209 to 223, F. Zijp et al where a device with system NA 1.9 is arranged to cooperate with a 50 GB optical record carrier without cover layer (first surface optical record carrier).

More general information on optical heads can be found in the Encyclopaedia of Optical Engineering DOI: 10.1081/E-EOE 120009664 (2003), Marcel Dekker Inc. Sections on tracking actuators, servo mechanisms, objective lens and advances in light paths are of particular relevance to this application.

Various kinds of optical record carriers can be used in conjunction with a near field-recording device. Some optical record carriers comprise a cover layer to protect data stored on the optical record carrier.

A problem with known near field optical recording devices is that the refractive optical element must be aligned very accurately with respect to the optical record carrier.

### SUMMARY OF THE INVENTION

It is an object of the invention to provide tilt control of the refractive optical element in a near field optical recording device, which is capable of providing better tilt control than for conventional systems, thereby improving alignment of refractive optical element with respect to the optical record carrier.

This object is achieved according to the invention in that the tilt servo gain setting is adjustable in response to a change in a distance between the refractive optical element and the at least one data layer.

In a further embodiment of the invention, the near field recording device further comprises a means for tilt servo gain adjustment for implementing at least one pre-determined value of the tilt servo gain in response to a change in a distance between the refractive optical element and the at least one data layer.

The control of tilt of the refractive optical element which is employed to direct light onto an optical record carrier in an optical recording device has been investigated for conventional optical systems. Near field recording systems, however, have special problems associated with the tilt due to the proximity required between the refractive optical element and the optical record carrier for near field operation. Special problems also occur when using a SIL lens due to the shape. Most SIL lenses are hemispherical or super hemispherical. In order to obtain sufficiently large margins for tilt of the optical record carrier with respect to the flat side of the SIL at such small working distances, the SIL usually has a conical shape with a small flat tip (often around 40 μm in diameter). However, even when the closest surface of the SIL is reduced in size from a millimeter to a few ten's of microns, the maximum allowed tilt angle is still very small (typically 0.07⁰ up to about 0.2⁰). This is quite different from current optical recording devices, where much larger mechanical tilts of the optical record carrier are possible (for example up to 1⁰ or more). For near field systems mechanical tilt margins are much smaller, so that it is difficult and expensive to accurately measure and correct disk tilt directly. Moreover, even a perfect alignment of the disk with respect to the optical axis may lead to a system failure if the front surface of the SIL is not exactly perpendicular to the optical axis (due to the manufacturing process, this indeed can be the case). In experimental near field devices, alignment can require tedious trial and error methods of alignment. This would not be acceptable in a commercial drive.

Earlier solutions to the problem of tilt, such as defocused spot methods or multi-spot methods all have the disadvantage that the alignment between SIL and disc needs to be sufficiently good before they can be used effectively. Because of the very tight mechanical tilt margins, this requires a pre-alignment step. This pre-alignment needs to be done on a static optical record carrier, and it is necessary to bring the lens and the carrier into contact to do the pre-alignment measurements (tilt measurement for pre-alignment can be done by using one of the earlier inventions, or by simply minimizing the GES signal level). Pre-alignment on a static disc is a disadvantage, as it increases the start-up time of the drive. Moreover, bringing the lens and disc into contact can potentially lead to damage and failure of the system.

In the invention use is made of the tilt error servo loop. This subsystem of the near field optical recording device is a means to adjust the tilt of the refractive optical element (used to direct light onto the optical record carrier) by detecting tilt and then using this as input for movement of the refractive optical element. This movement of the refractive optical element may be done using an actuator, for example. Thereby adjustment and compensation of the tilt is achieved. The conventional tilt error servo loop comprises a tilt error signal and a tilt error gain setting. The tilt error gain setting on prior art systems is factory adjusted in a commercial device to an optimum value for the device, which is independent of the distance between the refractive optical element and the optical record carrier. In the invention this gain setting is made adjustable by a means for tilt servo gain adjustment. A pre-determined value or pre-determined values for the tilt servo gain in different circumstances are made available and are implemented by the means for tilt servo adjustment. The values are determined and implemented according to the distance between the refractive optical element and a data layer of the optical record carrier. At different distances, different values of tilt gain setting are optimum for the operation of the near field optical recording device. (This will be explained later). Use of more appropriate gain setting values increases the accuracy of the tilt adjustment. As the invention can be implemented at different distances, it is then also possible to avoid a pre-alignment or coarse tilt adjustment step.

In a further embodiment of the invention, the distance between the refractive optical element and the at least one data layer comprises an air gap between the refractive optical element and a top surface of the optical record carrier. The air gap distance affects the sensitivity of the tilt signal generated to measure the tilt. The closer the refractive optical element is to the optical record carrier, the stronger the tilt signal becomes, although it remains periodic with the rotation frequency of the optical record carrier according to the fluctuations of the carrier. This behavior is seen for single light spots used for generation of tilt signals and for multispot arrangements.

The air gap in a near field optical recording system is often controlled using a gap error signal (GES). The gap servo system is started at relatively large distances of the refractive optical element from the optical record carrier, e.g. as couple of hundred nm's. At these distances the accuracy requirement for tilts is less tight than when the refractive optical element is at a working distance of e.g. 40 nm. Using the tilt signals at a particular distance a first correction of the tilt can be made. On a stationary disc the tilt signal will be d.c., on a rotating disc, the tilt signals will be a.c. in nature. Under control of the gap error signal, the refractive optical element cane be moved towards the optical record carrier. The tilt signal will change as the distance changes, and a pre-determined value of tilt servo gain can be implemented in the tilt servo loop by the means for tilt servo adjustment to optimize the tilt correction performance. One example of this optimization is adjustment of the tilt servo gain so that an overall gain setting of the tilt servo loop is adjusted to an optimum value. These steps can be repeated and incremented until the refractive optical element is at the desired working distance from the optical record carrier, with each step the tilt adjustment is tuned to tighter tolerances. The steps can also be made more frequent until the adjustment process is continuous and “on-the-fly”.

In a further embodiment of the invention, the distance between the refractive optical element and the at least one data layer comprises a layer depth between a top surface of the optical record carrier and the at least one data layer. In conventional optical devices focus of the device on a data layer is achieved by moving the objective lens of the device closer to or further from the optical record carrier. Due to the constraints of near field systems, where the near field is only available in close proximity to the optical record carrier, this mechanism for focus is not available. As the near field system moves focus from one layer to another layer on a multilayer optical record carrier (effectively a change in distance between the refractive optical element and the data layer under consideration), the size of the light spot at the exit face of the refractive optical element changes. This affects the tilt signal (see later). Provision of pre-determined values of tilt servo gain compensate for the changing spot size and allow consistent performance of the tilt compensation.

In a further embodiment of the invention, the distance between the refractive optical element and the at least one data layer comprises a layer depth of a cover layer of the optical record carrier. Optical record carriers are of different types. Some are so-called first surface discs where the data is read or written on the uppermost surface of the optical record carrier. Others comprise a coverlayer, which is a transparent layer placed over the data layer in order to protect the data from damage and dirt. The coverlayers can vary in thickness. This results in a distance variation between the refractive optical element and the data layer, which also affects the focus of the near field optical recording device on the data layer. Similar spot size changes and sensitivities in the tilt signals as described above can be influenced by provision of pre-determined values of tilt servo gain to allow consistent performance of the tilt compensation.

In a further embodiment of the invention, the at least one pre-determined value of the tilt servo gain is stored in a non-volatile memory component of the device. The values of tilt servo gain can be derived from measured or calculated sensitivity values for the tilt signal as dependent on e.g. air gap distance or coverlayer thickness. These values can be made available for use as part of the invention by storing the values in a non-volatile memory in the near field optical recording device. The value or values can then be retrieved at the appropriate moment when the distance of refractive optical element to data layer is at a point which corresponds to that related to the value or values of tilt servo gain.

In a further embodiment of the invention, the at least one pre-determined value of the tilt servo gain is automatically calculated. During a focus jump from one layer to the other, it is advantageous to simultaneously/synchronously adapt the tilt servo gain settings. For example, these intermediate settings can be derived by interpolating from the settings for the current and the next layer. In this way, the tilt servo performance, such as e.g. stability, remains optimal (i.e. same overall gain).

A method of operating a near field optical recording device, comprising the following steps:

Providing a means for tilt servo gain adjustment

Determining the distance between the refractive optical element and the at least one data layer

Using the means for tilt servo gain adjustment to apply the tilt servo gain setting in response to this distance

In a further embodiment of the invention, the method of operating an optical recording device comprises the following additional step:

Providing at least one pre-determined value of the tilt servo gain

### BRIEF DESCRIPTION OF THE DRAWINGS

The invention will be further elucidated with reference to the figures.

FIG. 1 shows a schematic diagram of the optical path of a near field optical recording device.

FIG. 2 shows the tilt signal dependency on air gap between a refractive optical element and an optical record carrier.

FIG. 3 shows the tilt accuracy requirements in relation to air gap size.

FIG. 4 illustrates the effect of changing focus between layers on a multi layer optical record carrier on the size of the light spot at the exit face of a SIL.

FIG. 5 shows tilt sensitivity as a function of coverlayer thickness of the optical record carrier and air gap between a refractive optical element and an optical record carrier.

FIG. 6 illustrates schematically a method of operating a near field optical recording device according one embodiment of the invention.

FIG. 7 shows the near field optical recording device of FIG. 1 incorporating one embodiment of the invention.

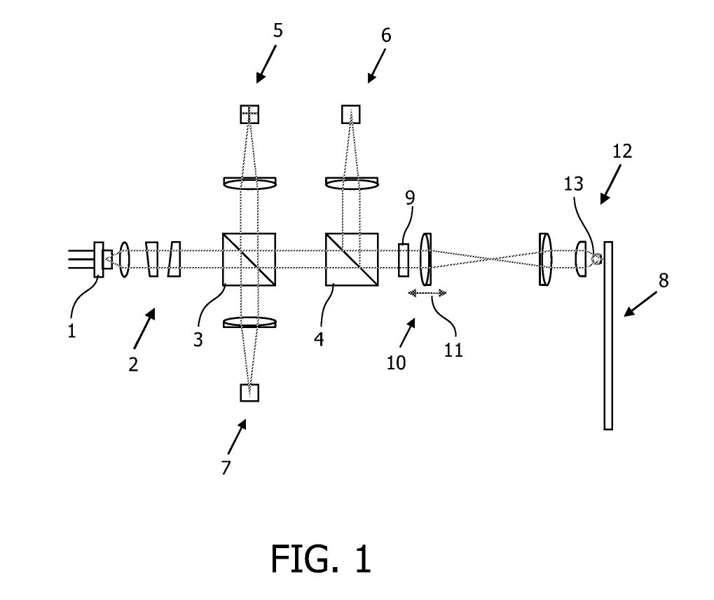

The layout of the optical path of a typical near field recording device is shown in FIG. 1. Light from a laser 1 is directed along a system of beam shaping optics 2. Light passes through a non polarizing beam splitter 3 and a polarizing beam splitter 4. These beam splitters are used in connection with systems for gap error signal and tilt detection 5 and RF data and push pull signals 6 and forward sense detectors 7, systems which permit tracking and control of the light spot (not shown) incident on the optical record carrier 8. Light passes through a quarter wavelength plate 9 and through a system of lenses for focus adjustment 10 of the light spot (not shown) on the optical record carrier 8. The direction of focus adjustment with respect to the optical path is indicated by the arrow 11. Light is focused onto the optical record carrier 8 by a system of lenses 12. This system of lenses 12 comprises the refractive optical element, usually a SIL (solid immersion) lens 13, which is the last lens element seen by the light before it is incident on the optical record carrier 8.

The tilt signal generated and detected 5 is subject to variation depending on the distance between the SIL lens 13 and the optical record carrier 8. This distance may take the form of an air gap between the SIL lens 13 and the optical record carrier 8, or it may take the form of a depth within the optical record carrier such as a cover layer thickness or a change in distance to move from one data layer to another.

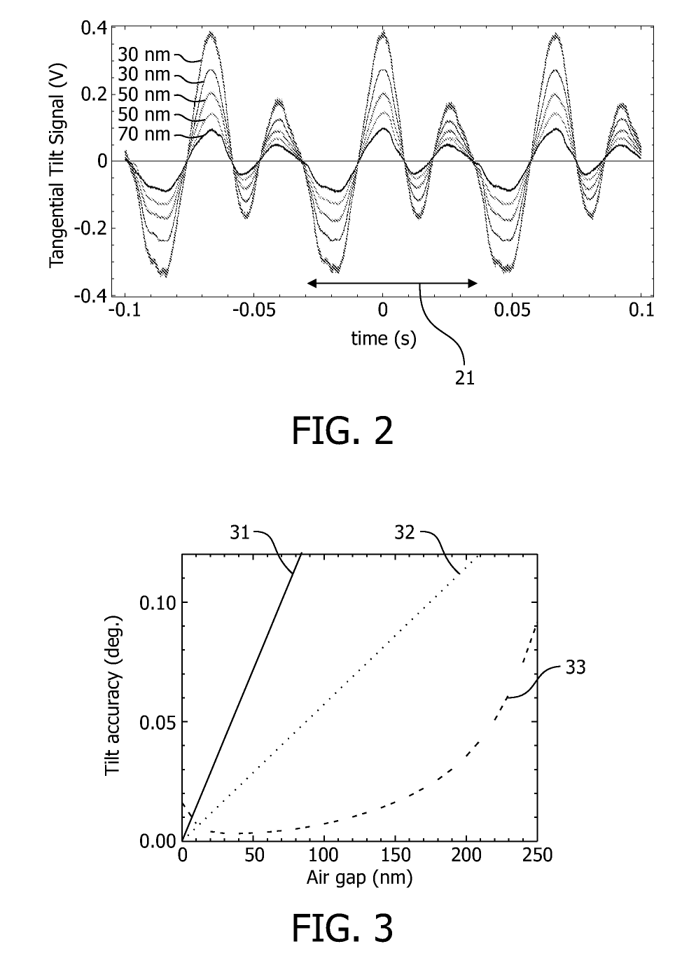

The graph of FIG. 2 shows how the tilt signal changes as the air gap is reduced between the SIL lens 13 and the optical record carrier 8. The tilt response is periodic in the graph, one period of rotation of the optical record carrier 8 being indicated by the arrow 21. In the illustration, the air gap is varied between 70 nm and 30 nm. At a larger air gap the tilt signal response is smaller than at a smaller air gap. Thus the tilt signal is more sensitive to tilt the closer that the SIL lens 13 is brought to the optical record carrier 8.

The specific example in FIG. 2 originates from experiment. In this experiment, an NA=1.45 lens was used to read-out a CuSi optical record carrier with a 3 μm cover-layer. This configuration yielded a defocused spot size on the bottom of the SIL of about 15 μm. Due to non-flatness of the optical record carrier, the tilt signal varied over the disc, and was periodic with the rotation frequency (indicated by arrow 21). Measuring the tilt signal for various air gaps showed a strong increase for smaller air gaps (while the actual tilt angle obviously remains the same). Comparing the experimentally found sensitivity vs. air gap with theoretical values showed good agreement. For a multi-spot tilt measurement, a similar behavior was found.

In order to achieve consistent and accurate tilt adjustment, the invention provides for a means for tilt servo gain adjustment which implements one or more values of tilt servo gain, thereby compensating for changes in the tilt signal caused by distance changes.

FIG. 3 is also related to air gap issues. The mechanical tilt tolerance depends on the SIL tip diameter: a larger diameter requires more accurate alignment. This effect is indicated for different SIL tip diameters by the straight lines 31 and 32 (solid=40 μm, dotted=100 μm), representing the required tilt accuracy for preventing mechanical contact (arbitrarily chosen as a factor 2 smaller than the mechanical tolerance). The dashed curve 33 is a numerical example of the accuracy of the multi-spot tilt signal (15 μm spot separation) versus air gap. This example is derived from the actual Gap Error Signal dependence on air gap of a recordable Near-Field optical record carrier with a 3 μm cover-layer at NA=1.45: at large air gaps, the GES dependence is weak (GES nearly constant), so that the tilt signal is not so accurate as for smaller air gaps, where the GES shows a strong dependence. Other disc types show a similar behavior. (Note that for very small air gaps, the GES again levels off, leading to a deterioration in the tilt signal accuracy. These air gaps are smaller than needed for optimum read-out and recording, and should preferably be avoided for good tilt control). From the figure it is evident that the tilt accuracy is better (smaller value) than required for the mechanical tilt tolerance for all relevant air gaps (30-150 nm), even for 100 μm tips.

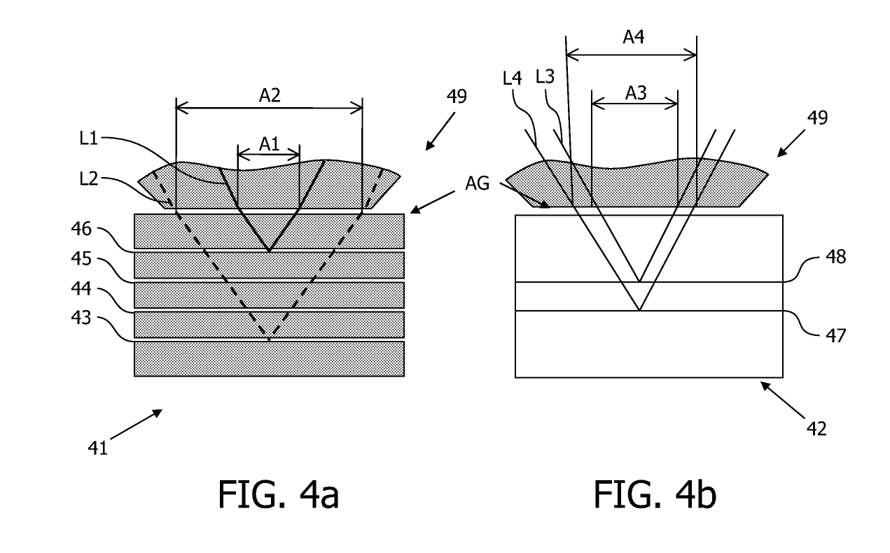

FIGS. 4a and 4b show multi layer optical record carriers 41 and 42 with data layers 43, 44, 45, 46 on optical record carrier 41 and data layers 47 and 48 on optical record carrier 42. A SIL lens 49 is positioned above the optical record carriers in turn. For read-out and recording of multiple layers, the spot size on the SIL's 49 exit surface depends strongly on the depth of the data layer to be read or written. Typical values of the spot size on the SIL 49 range from about 15 to 45 μm for a 4-layer disc with a cover thickness of 3 μm and spacer layer thickness of 2μm. This is discussed with reference to parts a and b of FIG. 4.

In FIG. 4a, the light beam indicated by LI is focused on data layer 46. The corresponding defocused light spot size at the exit face of the SIL 49 is indicated by arrow A1. When the light spot focus changes to data layer 43 and the light beam moves as indicated by L2, the defocused light spot size at the exit face of the SIL 49 is indicated by arrow A2. The air gap AG remains constant when reading or writing different layers, in contrast to earlier optical recording devices such as CD and DVD, where the focusing action is taken care of by changing the distance between lens and disc. In near field optical recording devices, this focusing action is carried out by e.g. an actuated collimator lens or a liquid crystal cell, or a combination. In a near field optical recording device, therefore, the defocused light spot size changes at the exit face of the SIL 49 as changes are made in the distance between the refractive optical element and the data layer. These spot size changes cause changes in the tilt signal detected. By means of the invention these changes can be compensated by use of an appropriate tilt servo gain value to ensure consistent operation of the device.

In FIG. 4b a similar effect is seen for changes in coverlayer thickness of the optical record carrier. The data layers 47 and 48 can be taken to represent two possible positions of the first data layer of an optical record carrier, layer 47 having a deeper coverlayer than data layer 48. Light beams L4 and L3 show the positions of the light spot at the exit face of the SIL 49 for the two possible cover layer depths. The associated sizes of spot associated with the light beams L4 and L3 are A4 and A3, respectively. Spot size A3 is smaller than spot size A4, with consequent changes in the tilt signal. By means of the invention these changes can be compensated by use of an appropriate tilt servo gain value to ensure consistent operation of the device.

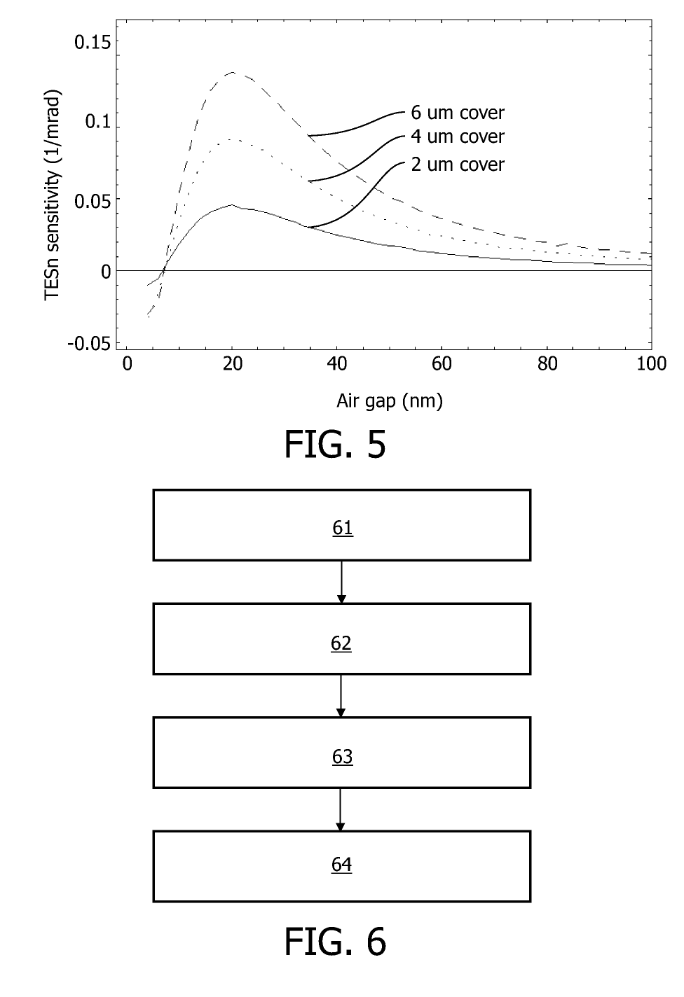

FIG. 5 shows the sensitivity of the tilt signal for various cover layer thicknesses and air gaps. For the data in the figure, the corresponding sot sizes on the SIL are 6, 12, and 18 μm. The tilt sensitivity increases for larger spot sizes and focus depths. If it is wished, for example, to keep the overall gain constant in the device servo loop, the tilt servo gain settings will have to be correspondingly smaller for consistent device performance.

FIG. 6 illustrates schematically a method of operating a near field optical recording device according to one embodiment of the invention. A method according to the invention starts with the step of providing a means for tilt servo gain adjustment 61. This means allows changes to be made in the tilt servo gain during operation of the device rather than during factory production and set-up. Next, at least one pre-determined value of the tilt servo gain should be known (more may be included if available or desired) such that a good working value for the tilt servo gain is available for one or more circumstances corresponding to distance between the SIL for example and the optical record carrier. This is an improvement on the situation where one gain value is constantly applied as it takes account of different sensitivities during device operation. The value or values are provided 62 and may be included in a non-volatile memory component of the near field optical recording device, for example. The near field recording device is capable of determining the distance between the refractive optical element and the at least one data layer 63. Usually this measuring of distance is achieved using a gap error signal. With determination of distance complete, the appropriate tilt servo gain setting can be implemented. Using the means for tilt servo gain adjustment the desired value of tilt servo gain is applied 64, the tilt servo gain setting corresponding to this distance.

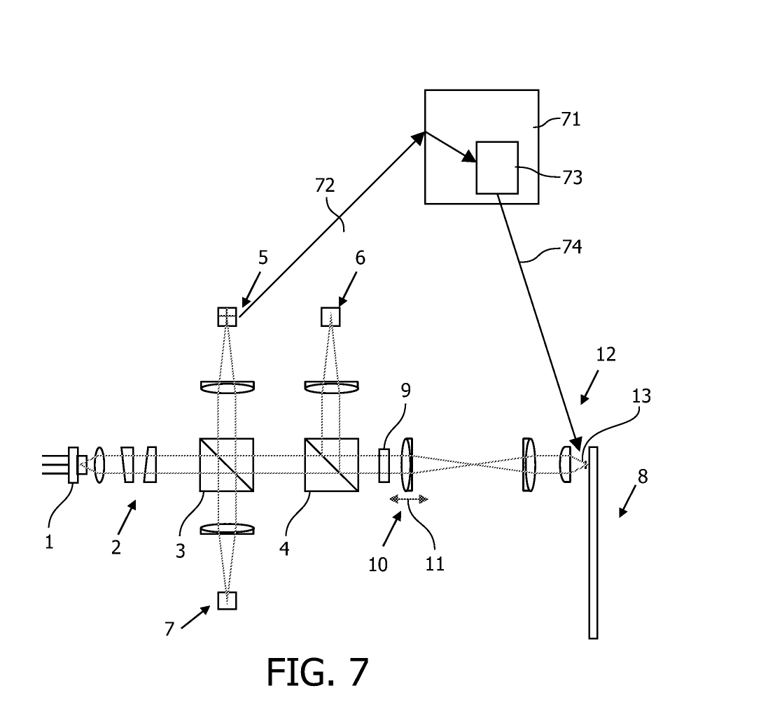

FIG. 7 shows the near field optical recording device of FIG. 1 incorporating one embodiment of the invention. Labels associated with FIG. 1 remain the same. The device now has input signals 72 to the tilt servo loop 71 of tilt error signal and distance signal derived from the gap error signal. These input signals 72 come from the system for gap error signal and tilt detection 5. The device also further comprises a means for tilt servo gain adjustment 73 according to the invention. This device is shown here as integral with the tilt servo loop 71 but may be an independent device located apart from the tilt servo loop structures. The means for tilt servo gain adjustment 73 sets the tilt servo gain and this signal is used in the tilt servo loop 71 to provide output 74 for tilt compensation of the SIL 13.

### LIST OF REFERENCE NUMERALS

1. Laser
2. Beam shaping optics
3. Non polarizing beam splitter
4. Polarizing beam splitter
5. System for gap error signal and tilt detection
6. System for RF data and push pull signals
7. Forward sense detector
8. Optical record carrier
9. Quarter wavelength plate
10. System of lenses for focus adjustment
11. Arrow indicating direction of focus adjustment
12. System of lenses
13. SIL lens
21. Arrow indicating one period of rotation of the optical record carrier
31. Line indicating effect for SIL tip diameter of 40 μm
32. Line indicating effect for SIL tip diameter of 100 μm
33. Curve showing numerical example of accuracy of tilt signal with respect to air gap
41. Multilayer optical record carrier
42. Multilayer optical record carrier
43. Data layer
44. Data layer
45. Data layer
46. Data layer
47. Data layer
48. Data layer
49. SIL lens
L1, L2, L3 and L4 light beam
A1, A2, A3 and A4 arrow indicating defocused light spot size at SIL exit face
AG air gap
61. Method step according to the invention
62. Method step according to the invention
63. Method step according to the invention
64. Method step according to the invention
71. Tilt servo loop
72. Input signals to tilt servo loop
73. Means for tilt servo gain adjustment
74. Output for tilt compensation

1. A near field optical recording device, the device being arranged to cooperate with an optical record carrier comprising at least one data layer, the device comprising:
a light source,
a refractive optical element arranged to direct light from the light source towards the optical record carrier,
a tilt error servo loop for providing a tilt error signal related to the tilt of the refractive optical element with respect to the optical record carrier,
and a tilt servo gain setting, applied to the tilt error signal,
characterized in that,
the tilt servo gain setting is adjustable in response to a change in a distance between the refractive optical element and the at least one data layer.

2. A near field optical recording device, as claimed in claim 1, the near field optical recording device further comprising a means for tilt servo gain adjustment for implementing at least one pre-determined value of the tilt servo gain in response to a change in a distance between the refractive optical element and the at least one data layer.

3. A near field optical recording device as claimed in claim 1, wherein the distance between the refractive optical element and the at least one data layer comprises an air gap between the refractive optical element and a top surface of the optical record carrier.

4. A near field optical recording device as claimed in claim 1, wherein the distance between the refractive optical element and the at least one data layer comprises a layer depth between a top surface of the optical record carrier and the at least one data layer.

5. A near field optical recording device as claimed in claim 1, wherein the distance between the refractive optical element and the at least one data layer comprises a layer depth of a cover layer of the optical record carrier.

6. A near field optical recording device as claimed in claim 1, wherein the at least one pre-determined value of the tilt servo gain is stored in a non-volatile memory component of the device.

7. A near field optical recording device as claimed in claim 1, wherein the at least one pre-determined value of the tilt servo gain is automatically calculated.

8. A method of operating a near field optical recording device, comprising the following steps:
providing a means for tilt servo gain adjustment
determining the distance between the refractive optical element and the at least one data layer
using the means for tilt servo gain adjustment to apply the tilt servo gain setting in response to this distance

9. A method of operating an optical recording device according to claim 8, comprising the following additional step:
providing at least one pre-determined value of the tilt servo gain
